(19) United States
(12) Patent Application Publication
(10) Pub. No.: US 2009/0240907 A1
(43) Pub. Date: Sep. 24, 2009

(54) REMOTE STORAGE ACCESS CONTROL SYSTEM

(76) Inventor: Jeffrey L. Crandell, Hermosa Beach, CA (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/404,821

(22) Filed: Mar. 16, 2009

Related U.S. Application Data
(60) Provisional application No. 61/037,717, filed on Mar. 19, 2008.

(51) Int. Cl. G06F 12/14; G06F 12/00; G06F 15/173

(52) U.S. Cl. 711/163; 711/E12.001; 711/E12.093; 709/226

(57) ABSTRACT

An authorization method includes recognizing a request to access a data storage unit from a user, providing user identification and identifying information of the data storage unit, receiving a response from the authorization module, and passing the request to the data storage unit if the user is authorized to access the data storage unit. An access control system includes the authorization module configured to receive the request to access the data storage unit from the client device and determine whether the user is authorized to access the data storage unit.

### CROSS-REFERENCE TO RELATED APPLICATIONS

This application claims the benefit of application Ser. No. 61/037,717 filed on Mar. 19, 2008, the contents of which are incorporated herein in their entirety.

### TECHNICAL FIELD

The present disclosure relates to data storage access control, and more particularly to access control of a local data storage unit provided by a remote server.

### BACKGROUND

An access control policy generally governs whether a user or device is authorized to use a resource. The resource may be a computing system, or a component thereof such as a data storage unit. For instance, in an environment with multiple computer systems and multiple users, an access control policy may determine which computing systems, and resources thereof, a user may access. The access control policy may establish different access rights for the same user on different computer systems. For instance, a user may be permitted to access all available storage units on his own computer system but may only be permitted to access a subset of the available storage units on a different computer system.

Typically, the operating system of a computer system has the responsibility of enforcing an access control policy. Operating systems typically provide a facility for connecting to or mounting a data storage unit and for controlling subsequent accesses thereto. An operating system may determine whether a user of the system should be allowed to access a storage unit based on access rights provided in the access control policy. An access control policy may be provided on a system by system basis or may be provided across a collection of computer systems. For instance, a remote server may provide the access control policy to a plurality of computing systems. However, even when a remote server provides the access control policy, the operating system of the client computer system continues to be responsible for implementing the policy. Accordingly, an access control policy, regardless of its implementation, may require the cooperation of the operating system.

Access control policies that are implemented by the operating system, regardless of whether a remote server provides the access control policy, may be defeated by dissociating the storage unit from the operating system. For instance, the host computer system may be operated with a different operating system that ignores the access control policy. Similarly, the storage unit may be physically removed from the host computer system and installed on another computer system that disregards the access control policy. Accordingly, removable or mobile storage devices that are not fixedly attached to a host computer system are most likely to be accessed in a manner that does not comport with an established access control policy.

### BRIEF DESCRIPTION OF THE DRAWINGS

Exemplary illustrations of the disclosure will now be described, by way of example, with reference to the accompanying drawings, wherein:

FIG. 1 is a system diagram of an exemplary remote storage access control system;

FIG. 2a is an exemplary removable data storage unit attached to a client computer system;

FIG. 2b is an exemplary removable data storage unit incorporating a biometric reader;

FIG. 2c is an exemplary removable data storage unit with an exposed controller and storage medium;

FIG. 3a is a flowchart depicting exemplary steps and decisions related to an access control module;

FIG. 3b is a flowchart depicting exemplary steps and decisions related to an another access control module;

FIG. 4 is a flowchart depicting exemplary steps and decisions related to an access request module; and

FIG. 5 is a flowchart depicting exemplary steps and decisions related to an authorization module.

### DETAILED DESCRIPTION

The present disclosure relates to data storage access control, and more particularly to access control of a local data storage unit provided by a remote server.

Exemplary illustrations of a remote storage access control system are described below. In the interest of clarity, not all features of an actual implementation are described in this specification. It will of course be appreciated that in the development of any such actual illustration, numerous implementation-specific decisions must be made to achieve the developers' specific goals, such as compliance with system-related and business-related constraints that will vary from one implementation to another. Moreover, it will be appreciated that such a development effort might be complex and time-consuming, but would nevertheless be a routine undertaking for those of ordinary skill in the art having the benefit of this disclosure.

Referring now to the drawings wherein like numerals indicate like or corresponding parts throughout the several views, exemplary embodiments are illustrated.

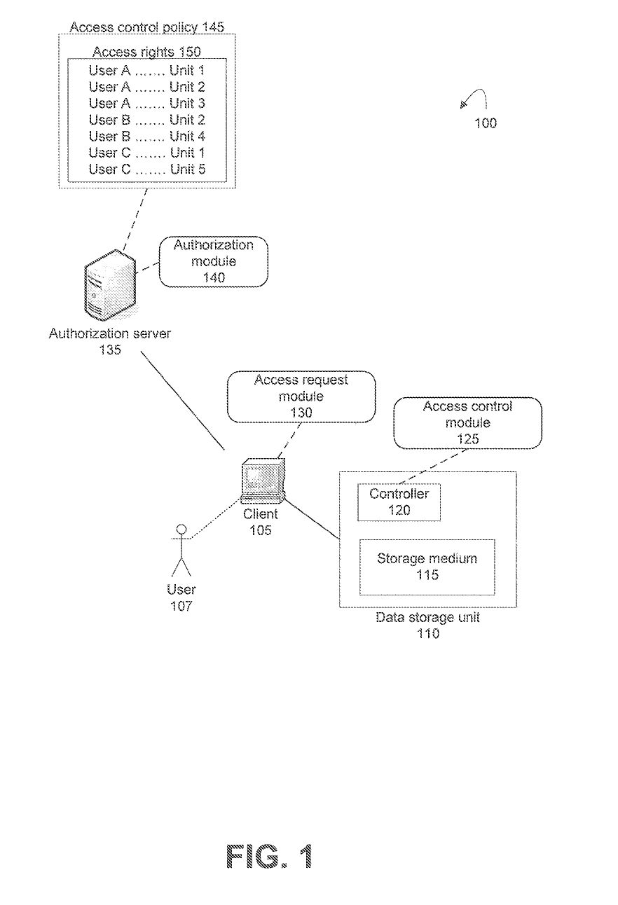

FIG. 1 illustrates an exemplary remote storage access control system 100. The system 100 may include a client 105, which may be operated by a user 107, connected to a data storage unit 110. The data storage unit 110 may include a storage medium 115 accessible through a controller 120. As discussed above in the background section, a typical client 105 may rely on the operating system to include instructions for communicating with the controller 120 to access the storage medium 115. The operating system may further implement an authorization or access control policy that determines whether the user 107 is allowed to access the data storage unit 110. However, relying on the operating system of the client 105 to enforce the access control policy may allow the policy to be defeated by dissociating the data storage unit 110 from the client 105.

Accordingly, the remote storage access control system 100 may further provide an access control module 125, an access request module 130, and an authorization module that cooperate to enforce an access control policy 145. The access control policy 145, including access rights 150, may be provided by an authorization server 135 that is remote from the client 105. Providing the access control policy 145 on a remote server 135 may allow for multiple clients 105 (only one shown) to use the same access control policy 145. The remote storage access control system 100 may add an additional layer of access control to any access control provided by the operating system of the client 105. The controller 120 of the storage unit may implement the access control module 125, which may require a properly formatted access command and/or the receipt of an authorization token prior to granting access to the storage medium 115.

The remote storage access control system 100 may be particularly useful when the entity that establishes the access control policy 145, i.e., a controlling entity, does not have the authority or ability to control the client 105. For example, the prevalence of mobile or removable data storage units 110 may allow a data storage unit 110 to be used with numerous clients 105 that lack the knowledge or ability to enforce the access control policy 145. The controlling entity may wish to enforce an access control policy 145 for removable storage units 110 that are intended to be used in the field or generally in an unknown environment. Circumstances related to the access rights 150 may change after the controlling entity loses physical custody of the removable storage unit 110. For example, a data storage unit 110 may become lost or stolen. Similarly, a user 107 that was initially granted an access right 150 to a data storage unit 110 may have the access right 105 revoked without the need to regain physical custody of the unit 110.

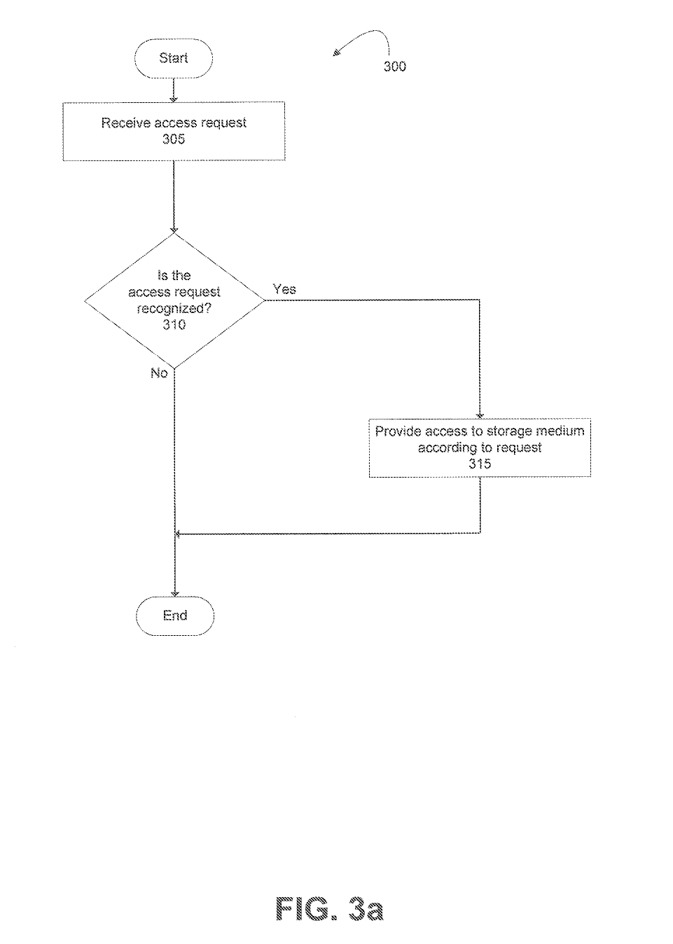

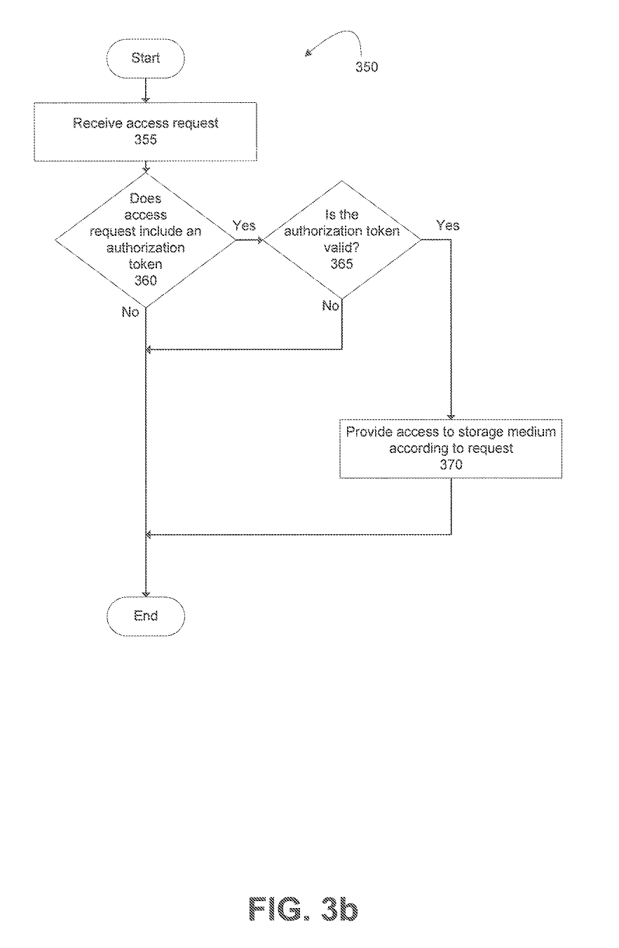

Details of exemplary processes are provided below with respect to FIGS. 3-5. However, a brief overview of the interactions between the components of the system 100 is provided to demonstrate an exemplary sequence of communications. The user 107 of the client 105 may wish to access the data storage unit 110. The user 107 will instruct the client 105, typically though the use of the operating system of the client 105, to access the data storage unit 110. The access request module 130 may recognize the access request. The access request module 130 may then communicate with the authorization module 140 to determine whether the user 107 is authorized to access the data storage unit 110. The authorization module 140 may consult the access rights 150 of the access control policy 145 to determine if the user is authorized. The authorization module may then inform the access request module 130 that the user 107 is authorized. The access request module 130 may then pass the request to the data storage unit 110. In some exemplary approaches, the request may need to be formatted according to a predetermined format of the data storage unit 110. In other exemplary approaches, an authorization token may be included with the request. The access control module 125 may allow the client 105 to access the data storage unit 110 based on the request being properly formatted or based on the authorization token being valid.

The remote storage access control system 100 may operate across at least one computer network. The line between the authorization server 135 and the client 105 represents generalized network connection. The Network connection may be provided by a local area network (LAN), wide area network (WAN), as well the Internet. The actual connection may be made by various media including wires, radio frequency transmissions, and optical cables. Intervening networks and network devices, e.g. switches, routers, etc., that may be present in an implementation of the system 100 are omitted for simplicity of illustration.

The client 105 may be any general purpose computing device, such as a PC, or a specialized device. The client 105 may have software, such as an operating system with a network protocol stack, for establishing network connections to authorization server 135. The operating system may include other software for accessing the data storage unit 110. The operating system software for accessing the data storage unit 110 may be augmented with additional software, such as the access request module 130, configured to communicate with the access control module 125. The access request module 130 may also communicate with the authorization module 140 to determine the access control policy 145. The access request module 130 and the authorization module 140 may communicate via a predefined communication protocol. For instance, if the authorization server 135 is a web application server, the access request module 130 may implement the Hyper Text Transfer Protocol (HTTP) to communicate with authorization module 140.

Data storage unit 110 may be any general purpose or specialty storage device capable of implementing the access control module 125. Data storage unit 110 may include a controller 120 and a storage medium 115. The connection between the data storage unit 110 and the client 105 may implement a data transmission bus. The client 105 may include a bus or host controller (not show) that connects via the bus to the controller 120. The controller 120 may regulate the storage and retrieval of data to and from the storage medium 115. The storage medium 115 may be a magnetic disk or a solid state device. A solid state storage medium 115 may include flash memory such as NAND based electrically erasable programmable read-only memory (EEPROM). The controller 120 may implement a bus protocol such as the universal serial bus (USB), and more particularly the USB mass storage device class. In one exemplary approach, data storage unit 110 may include a customized controller 120 that is configured to determine if a request to access the storage medium 115 includes a valid authorization token.

The authorization token may be any data element used to verify that a request is authorized. In one approach, the authorization token may be a serial number of the data storage unit 110. To be an effective authorization token, the data element typically will not be easily discoverable. Accordingly, the authorization token may be generated by the access control module 125 during an initialization process. The initialization process may use random data or a timestamp associated with the initialization process in order to produce an authorization token that can not be determined prior to its creation or similarly reproduced thereafter. The authorization token may be stored in a separate storage partition of the storage medium 115. The separate storage partition may be accessible by the controller 120 but not by the operating system of the client 105. In another exemplary approach, the token may be stored on a portion of the storage medium that is not mapped to the storage partition presented to the operating system of the client 105.

In yet another exemplary approach, there may not be a single authorization token. An authorization token may be produced for each access request, each user 107, or on some other periodic basis. The access request module 130 and the access control module 125 may include corresponding token generation algorithms. The access control module 125 may provide the access request module 130 with a seed value for the token generation algorithm during the initialization process. The seed value may allow the two algorithms to produce corresponding authorization tokens that may be used on a one-time-basis or similar limited number of uses.

The authorization server 135 may be an application server such as a web application server. Application servers generally provide access to various facilities that combine programming logic, processing power, and data and file access. The authorization module 140 may provide software instructions that implement an access control policy 145. While not depicted, the access control policy 145 may be implemented with a data store such as a relational database management system, a directory service, etc. The authorization server 135 may provide the access control policy 145 to the client 105 from a remote location.

Web application servers may allow for access to computer program logic through an HTTP interface. Accordingly, web application servers typically provide an interface of procedures or functions, layered over top of HTTP, that may be called upon by remote computing devices, e.g. client 105. Accordingly, the client 105 may execute so-called remote procedure calls on the authorization server 135. Moreover, the remote device generally initiates the procedures on the authorization server 135 due to the nature of the underlying HTTP server. The authorization server 135 may communicate with the remote device, e.g. the client 105, in response to a specific request or remote procedure call. The functions and procedures that are remotely available may be included in the authorization module 140. The authorization module 140 may further include additional software or programming logic outside of any remote procedures that is necessary to provide the authorization policy to the client 105.

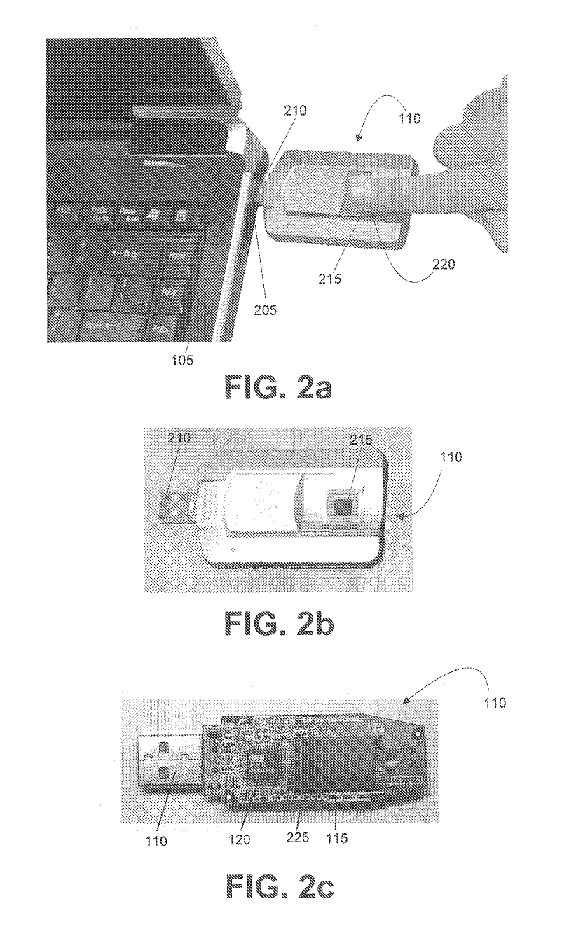

FIGS. 2a-c illustrate exemplary data storage units 110. The data storage unit may be a removable USB device that connects to a USB port 205 on the client 105. Such a data storage unit 110 is commonly referred to as a USB flash drive indicating that it includes a USB connector 210 and provides the storage medium 115 as solid state flash memory. However, unlike a standard USB flash drive, the controller 120 of a USB based data storage unit 110 may implement the access control module 125 in addition to the USB mass storage device protocol. The controller 120 and storage medium 115 may be included on a printed circuit board 225.

A biometric reader may be used by client 105 for receiving credentials from the user 107. As will be discussed in more details below, the credentials may be used to authenticate the user 107 prior to determining if the user 107 is authorized to access the data storage medium 110. The biometric reader 215 may be included with a flash memory data storage unit 110 that is removably attached to client 105. In another exemplary approach, the biometric reader may be a peripheral device (not shown) attached to client 105. Biometric readers 215 may be available for determining different biometric attributes including fingerprints, palm prints, retina patters, facial shapes, voice signatures, etc. The biometric reader 215 may store a previously recorded template of the particular biometric attribute, e.g., a fingerprint 220. This template may be compared to a current biometric reading or scan. Some biometric readers 215 may convert the biometric reading into a secured passkey upon a successful match with the template. The secured passkey may then be provided to the authorization module 140 for authentication. An exemplary method of producing a passkey from a biometric reading may be found in PCT Patent Application PCT/US06/01900.

Computing devices such as authorization server 135, client 105, etc., may employ any of a number of computer operating systems known to those skilled in the art, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Computing devices may include any one of a number of computing devices known to those skilled in the art, including, without limitation, a computer workstation, a desktop, notebook, laptop, or handheld computer, or some other computing device known to those skilled in the art.

Computing devices such as authorization server 135, client 105, etc., may each include instructions executable by one or more computing devices such as those listed above. Computer-executable instructions may be compiled or interpreted from computer programs created using a variety of programming languages and/or technologies known to those skilled in the art, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, and volatile media. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

In the following exemplary process steps, both the client 105 and the user 107 operating the client 105 may be the subject of the authorization as well as any authentication. Accordingly, the use of the term client 105 rather than user 107 should not be seen as limiting the exemplary step to only the client 105. Similarly, exemplary steps may indicate that the user 107 may be providing user input such as credentials. However, the client 105 may be providing the input programmatically, e.g. through a data file or other information accessible to the client 105.

FIGS. 3a and 3b illustrate flowcharts of exemplary processes 300 and 350 for accessing the storage medium 115 of the data storage unit 110. The data storage unit 110 may include a computer-readable medium having stored instructions for carrying out certain operations described herein, including some or all of the operations described with respect to processes 300 and 350. For example, some or all of such instructions may be included in the access control module 125. Processes 300 and 350 are described as interactive user processes. However, it is to be understood that automated or other types of programmatic techniques may implement the following steps.

The process 300 begins in step 305 when the data storage unit 110 receives an access request. There may be an initial access request that occurs with a first attempt to access the data storage unit 110 by the client 105. For example, the client 105 may automatically attempt to access or mount the data storage unit 110 at the time the operating system boots or starts-up. Similarly, there may be an automatic mounting attempt when a removable data storage unit 110 is associated with the client 105. Additional access attempts may occur after mounting such as in a request to store or retrieve data from the storage medium 115. In one exemplary approach, the access control module 125 may require authorization prior to mounting. In another exemplary approach, the access control module 125 may only require authorization for subsequent access attempts. In another exemplary approach, the access control module 125 may require authorization of both the initial mounting and subsequent access attempts.

Next, in step 310, it may be determined whether the access request is recognized. The access control module 125 may be configured to only recognize requests that are formatted according to a predetermined communications format or protocol. For instance, the access control module 125 and the access request module 130 may share a private protocol of instructions and commands. To reduce the risk of the private protocol becoming known, the communications between the access control module 125 and the access request module 130 may be encrypted. In another exemplary approach to ensure that the access request module has not been modified or replaced with an un-trusted application, the access control module 125 may verify a checksum or hash of the access request module 130 against a predetermined value.

While not necessarily a step of process 300, client software for accessing the data storage unit 110, e.g. access request module 130, may be stored on the data storage unit 110. For instance, data storage unit 110 may have a second storage medium (not shown) that can be mounted by the operating system of the client 105 regardless of whether the client 105 provides a valid authorization token. Including the client software on the data storage unit 110 may facilitate the use of a removable or mobile data storage unit 110.

Next, in step 315, access to the storage medium 115 may be provided according to the request. For instance, if a segment of data, such as a file, was requested, then that segment of data may be read out of the storage medium 115 and provided to the client 105. If the request provided data for storage, the data may be written or stored to the storage medium 115. Following step 315, the process 300 may end.

Process 350 describes steps for another exemplary approach to implementing the access control module 125. Process 350 includes the use of an authorization token. Process 350 begins in step 355 when the data storage unit 110 receives an access request. As discussed above in step 305, the access request may be an attempt to mount the data storage unit 110 or may be a subsequent read or write operation directed at the storage medium 115.

Next, in step 360, it may be determined whether the access request includes an authorization token. The request might not include an authorization token if the client 105 has not been authorized by the authorization module 140. For instance, the access request module 130 which communicates with the authorization module 140 in order to authorize the client 105 may not be present on the client 105 or might not by functioning properly. For instance, the access request module 130 might have been disabled in an attempt to circumvent authorization. Also, a removable data storage unit 110 may be associated with a client 105 that lacks the access request module 130.

In one exemplary approach, there may be an additional initialization step (not shown) in which the access request module 130 receives the authorization token from the data storage unit 110. In another exemplary approach, rather than receiving the authorization token itself, the access request module 130 may receive information from the data storage unit 110 that can be used to generate multiple authorization tokens. For instance, a token generation algorithm may be included with the access request module 130. The data storage unit 110 may provide a seed value to the token generation algorithm. In addition to the seed value, the token generation algorithm may further rely on a timestamp associated with the time of access to provide a single use authorization token.

If the request does not include an authorization token, process 350 may end. However, if the request does include an authorization token, the token may be validated in step 365. In one approach, the data storage unit 110 may include a master copy of the valid authorization token. The master copy may be compared with the token provided with the request to see if there is a match. In another exemplary approach, there may be no master authentication token because the tokens may only be valid for a limited number of uses, e.g. only a single use. The data storage unit 110 may include a token generation algorithm seeded with the same value as the token generation algorithm provided by the access request module 130. The data storage unit 110 may be able to calculate a corresponding authorization token to compare with the token provided with the access request. If the authorization token is not valid the process 350 may end. However, if the authorization token is valid, the process may proceed to step 370.

Next, in step 320, access to the storage medium 115 may be provided according to the request. For instance, if a segment of data, such as a file, was requested, then that segment of data may be read out of the storage medium 115 and provided to the client 105. If the request provided data for storage, the data may be written or stored to the storage medium 115. Following step 320, the process 300 may end.

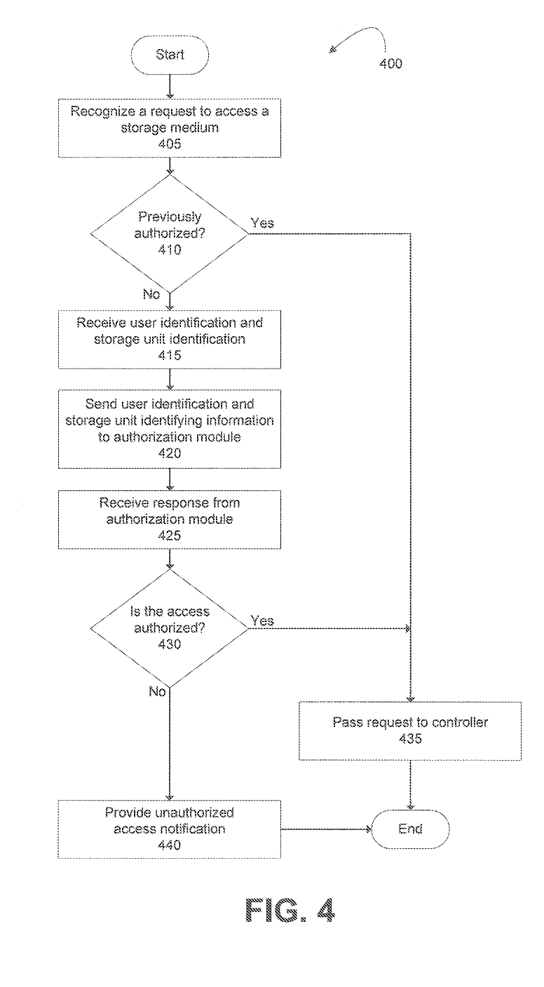

FIG. 4 illustrates a flowchart of an exemplary process 400 for handling authorization. The client 105 may include a computer-readable medium having stored instructions for carrying out certain operations described herein, including some or all of the operations described with respect to process 400. For example, some or all of such instructions may be included in the access request module 130.

The process 400 begins in step 405 when a request to access the data storage unit 110 may be recognized or intercepted. As discussed above, the request may be a request to initially mount the data storage unit 110 as a drive. The request may also be a subsequent read or write operation to the storage medium 115.

Next, in step 410, it may be determined whether the user 107 has been previously authorized to access the data storage unit 110. For instance, once authorized, a user 107 may continue to be authorized for a certain period of time, a certain number of accesses, etc. In another exemplary approach, each access to the data storage unit 110 may require a renewed authorization. In such an approach, this step 410 may be excluded. If the user 107 is not currently authorized, the process may proceed to step 415.

In step 415, user identification and storage unit identification may be received. The user identification and storage unit identification may be provided by the client 105 or the user 107 based on the design choices of the particular implementation. For the sake of explanation, the remainder of this step will be discussed in the context of the user 107 providing the user identification and storage unit identification. The remote storage access control system 100 generally requires a user 107 to be identified prior to being authorized. Accordingly, the user identification received in step 415 may be used to identify the user 107. For instance, the user name or user ID as reported by the operating system of the client 105 may be used as the user identification. In another exemplary approach, the user identification may include credentials used to authenticate the user 107. The credentials may be in the form of a user name and password. For instance, the access request module may provide a graphical user interface on the client 105 for the user 107 to provide a user name and password. In another exemplary approach, the credentials may be provided by a biometric reader 215. The access request module may prompt the user 107 to submit to a biometric scan. In another exemplary approach, the operating system of the client 105 may be relied upon to authenticate the user 107. For instance, the user 107 may be required to be authenticated prior to use of the client 105. Rather than requiring an additional authentication of the user 107, the result of the authentication by the operating system may be used as the user identification.

Next, in step 420, the user identification and storage unit identification may be provided to the authorization module 140 for authorization. In some exemplary approaches, the authorization module 140 may also authenticate the user 107 based on the user information.

Next, in step 425, a response may be received from the authorization module 140. While depicted as a sequential step, other steps, such as those in process 500 may occur between steps 420 and 425.

Next, in step 430, it may be determined whether access was authorized. For instance, the response received in step 425 may include a message, or the like, indicating the authorization status of the user 107. In an approach that uses authorization tokens, the authorization module 140 may be responsible for generating the authorization token. In such an approach, the token may be included with the response from step 425 if the user 107 was successfully authorized. Similarly, a response that lacks an authorization token may provide the indication that the user 107 was not authorized (see step 440). If the user 107 has been authorized, the process may proceed to step 435.

In step 435, the request that was recognized or intercepted in step 405 may be passed to the controller 120 of the storage unit 110. In one exemplary approach, the access request will be formatted according to the predetermined communication protocol of the controller 120. The predetermined communication protocol may be a private or secret protocol or set of instructions shared only between the access request module 130 and the access control module 125. In some exemplary approaches, the communications between the client 105 and the controller 120 may be encrypted using public key encryption, or the like. In another exemplary approach, the access control module 125 may verify a checksum such as a hash of the access request module 130 to determine that the access request module 130 has not been modified.

In another exemplary approach, an authorization token may be included with the request. In one exemplary approach, the authorization token is provided by the authorization module 140. In another exemplary approach, the authorization token is stored on the client 105 and included with the request only if the access is authorized according to step 430. In yet another exemplary approach, an authorization token may be generated by the access request module 130. For instance, the authorization token may be generated for each authorized user, for each access request, etc. In any approach using an authorization token, a hash or other derivative of the token may be used to avoid revealing the actual token.

Following step 435, process 400 ends.

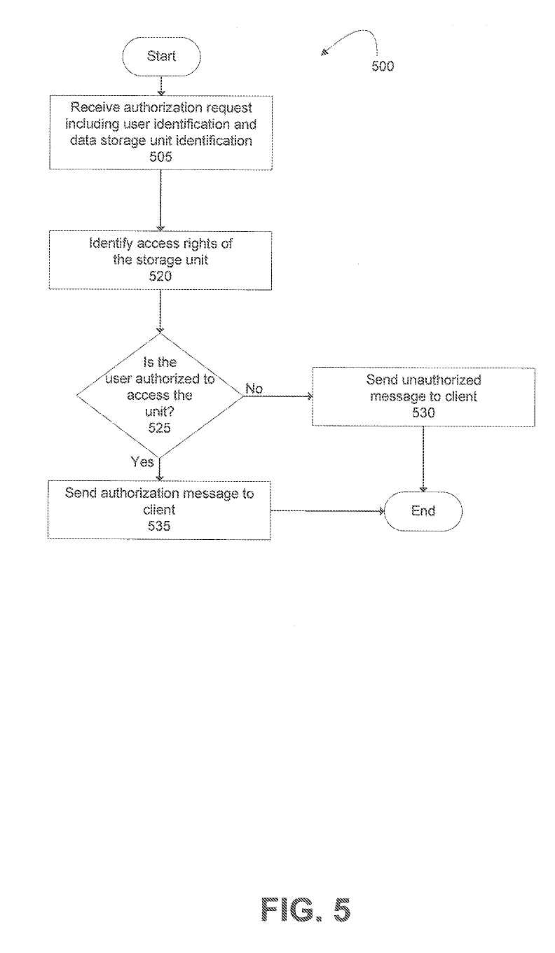

FIG. 5 illustrates a flowchart of an exemplary process 500 for authorizing the user 107. The authorization server 135 may include a computer-readable medium having stored instructions for carrying out certain operations described herein, including some or all of the operations described with respect to process 500. For example, some or all of such instructions may be included in the authorization module 140.

The process 500 begins in step 505, in which the authorization module 140 receives an authorization request from the access request module 130. The access request may include information that identifies the data storage unit 110 that the user 107 seeks to access. The information may be any arbitrary or meaningful identifier that uniquely identifies the data storage unit 110 within the remote storage access control system 100. The request may also include the identification of the user 107.

In another exemplary approach, the user 107 may also be authenticated by the access request module 130. In such an approach, the identification of the user 107 may be determined by credentials provided with the request. In one exemplary approach, the credentials may be a user name and password entered by the user 107. The client 105 may validate the user name and password locally or may rely on the authorization module 140 to provide the validation. The username and password may be converted to an irreversible representation using a hashing algorithm, or the like. Such a conversion may prevent the discovery of the username and password if the transmission between the client 105 and authorization server 135 were ever intercepted.

In another exemplary approach using a biometric reader 215, the user 107 may have submitted to a biometric scan by placing a finger 220 against the reader 215. The biometric reader 215 may convert the scan into a representation suitable for comparison to a previously stored scan. The degree of correspondence between the previously stored scan and the instant scan may be determined. If the degree of correspondence exceeds a threshold, it may be determined that the scans match. If the scans are determined to match, the scan may be converted to an irreversible representation for transmission to the authorization module 140. For instance, the scan may be converted into a secure passkey.

In an approach that includes authentication, it may be determined whether the credentials authenticate the user 107. In one exemplary approach, the user 107 may be authenticated by the operating system of the client 105. In such an approach, the credentials may simply be a user name or user ID that identifies the user 107. This approach trusts the client 105 to authenticate the user 107. However, in other exemplary approaches that do not rely on the operating system of the client 105 for authentication, the credentials may be used by the authorization module 140 to first authenticate the client 105 prior to determining whether the client is authorized to access the data storage unit 110.

As discussed above, the credentials may be a derivative of the actual credentials that were provided by the user 107. The credentials received in this step 505 may be transformed, such as through a hash or other types of algorithms, in order to provide a value that cannot be used to determine the actual credentials provided by the user 107. In one exemplary approach, the credentials are a passkey generated by the client 105 using the actual credentials provided by the user 107. The authorization module 140 may include credentials provided by the user 107 at an earlier time. The previously recorded credentials may be compared with the credentials that were received in step 505. If the credentials correspond to the previously recorded credentials the user 107 may be authenticated. If the user 107 is not authenticated, an authentication failure message may be provided to the client 105 prior to process 500 ending.

In step 520, the access control policy 145 may be retrieved. The access control policy 145 may identify access rights 150 through mappings between user 107 and data storage units 110. The access control policy 145 may be stored in a data store such as a database, a directory service, etc. The access control policy 145 may be queried based on the user identifier to determine the access rights 150 associated with the user 107.

Next, in step 525, it may be determined whether the user 107 is authorized to access the data storage unit 110. The access rights 150 identified in step 520 may indicate to which, if any, data storage units 110 the user 107 has access. The identifying information of the data storage unit 110 that was provided in step 505 may be used along with the access rights 150 retrieved in step 520 to determine if the user is authorized to access the unit 110. As discussed above, the access rights 150 may provide additional information regarding any constraints that may be placed on the user 107 with respect to accessing the device. For instance, the access rights 150 may indicate that the user 107 is only allowed to access the unit 110 on a read-only basis.

In step 530, an unauthorized message may be provided to the client 105 if the access rights 150 indicate that the user 107 is not authorized to access the data storage unit 110.

In step 535, an authorization message may be provided to the client 105 if the access rights 150 indicate that the user 107 is authorized to access the data storage unit 110. If the access control policy 145 implements authorization constraints or levels, e.g. read-only access, the authorization constraints may be provided with the message. In another exemplary approach, the authorization module 140 may be responsible for providing the authorization token. In this approach, the authorization message may also include the authorization token.

Following steps 530 and 535, the process 500 may end.

Accordingly, exemplary systems and methods of remote authorization have been described. The exemplary systems and methods may facilitate the implementation of an access control policy 145 across a network of remote data storage units 110. The system 100 may be particularly suited to data storage units 110 that can be disassociated, or removed, from a client 105. An access control module 125 may require any access attempts to the data storage unit 110 to include a valid authorization token or to communicate according to a predetermined communication protocol. The access request module 130 may consult with an authorization module 140 that has access to the access control policy 145 and access rights 150 to determine if a user 107 attempting to access the data storage unit 110 is authorized. If authorized, either the access request module 130 may format an access request according to the predetermined communication protocol and/or may provide the valid authorization token that will be included with the access request.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. An authorization method, comprising:
recognizing a request to access a data storage unit from a user;
providing user identification and identifying information of the data storage unit to an authorization module;
receiving a response from the authorization module indicating whether the user is authorized to access the data storage unit; and
passing the request to the data storage unit if the user is authorized to access the data storage unit.

2. The method of claim 1, further comprising determining whether the user was previously authorized to access the data storage unit.

3. The method of claim 1, further comprising receiving an authorization request, user identification, and identifying information at the authorization module.

4. The method of claim 1, further comprising identifying access rights of the data storage unit.

5. The method of claim 1, further comprising sending an authorization message to the user if the user is authorized to access the data storage unit.

6. The method of claim 1, further comprising sending an unauthorized message to the user if the user is not authorized to access the data storage unit.

7. The method of claim 1, wherein the authorization module operates on a remote server.

8. The method of claim 1, further comprising formatting the request according to a predetermined format of the data storage unit.

9. The method of claim 1, further comprising receiving an authorization token with the request.

10. An access control system comprising:
a data storage unit;
a client device in communication with said data storage unit; and
a remote server having an authorization module in communication with said client device, wherein said authorization module is configured to receive a request to access said data storage unit from said client device and determine whether a user is authorized to access said data storage unit.

11. The access control system of claim 10, wherein said authorization module is further configured to receive user identification from said client device and identifying information of the data storage unit.

12. The access control system of claim 10, wherein said client device is configured to receive a response from said authorization module indicating whether the user is authorized to access the data storage unit.

13. The access control system of claim 10, wherein said client device is configured to pass the request to the data storage unit if the user is authorized to access the data storage unit.

14. The access control system of claim 10, wherein said access control module is configured to receive the request to access said data storage unit, determine whether the request is valid, and provide access to said data storage unit if the request is valid.

15. The access control system of claim 14, wherein the request is determined to be valid based on the request being formatted according to a predetermined format of said data storage unit.

16. The data storage unit of claim 14, wherein the request is determined to be valid based on an authorization token received with the request.

17. The access control system of claim 10, wherein said client device includes an access request module configured to recognize the request to access said data storage unit.

18. The access control system of claim 18, wherein said data storage unit includes:
a storage medium; and
a controller interconnecting said storage medium with said client device, wherein the controller implements an access control module configured to receive the request to access said storage medium from said client device, determine whether the request is valid, and provide access to said storage medium if the request is valid.

19. The data storage unit of claim 18, wherein the request is determined to be valid based on the request being formatted according to a predetermined format.

20. The data storage unit of claim 18, wherein the request is determined to be valid based on an authorization token received with the request.

21. An access control system comprising:
a data storage unit having a storage medium and a controller;
a client device in communication with said data storage unit; and
a remote server having an authorization module in communication with said client device, said authorization module being configured to receive a request to access said data storage unit from said client device, determine whether a user is authorized to access said data storage unit, and receive user identification from said client device and identifying information of the data storage unit,
wherein said client device is configured to receive a response from said authorization module indicating whether the user is authorized to access the data storage unit and pass the request to the data storage unit if the user is authorized to access the data storage unit, and
wherein said controller implements an access control module configured to receive the request to access said storage medium from said client device, determine whether the request is valid, and provide access to said storage medium if the request is valid.
